(19) United States
(12) Patent Application Publication
(10) Pub. No.: US 2004/0073439 A1
(43) Pub. Date: Apr. 15, 2004

(54) Method and apparatus for issuing a non-transferable ticket

(75) Inventor: Gary Stephen Shuster, Fresno, CA (US)

Correspondence Address: Brian M. Berliner, O'MELVENY & MYERS LLP, 400 South Hope Street, Los Angeles, CA, 90071-2899, US

(73) Assignee: IDEAFLOOD, INC.

(21) Appl. No.: 10/397,481

(22) Filed: Mar. 26, 2003

Related U.S. Application Data
(60) Provisional application No. 60/367,791, filed on Mar. 26, 2002.

(51) Int. Cl. G06F 17/60

(52) U.S. Cl. 705/1; 713/200

(57) ABSTRACT

A method and apparatus for issuing a non-transferable ticket for a transient event are intended to prevent ticketed persons from improperly transferring non-transferable tickets. The method includes receiving a request for a ticket to a transient event, such as boarding a vessel for a specified passage, or attending an entertainment event. The ticket request identifies a ticketed person and a ticketed event. The method further includes confirming a ticketed person identity using a recorded identification document. An image of the ticketed person is obtained, such as by taking a digital image of the ticketed person's face. The ticketed person image is fixed with ticket data in a suitable media, such as on a paper ticket, and the ticket is issued. Because of the presence of the fixed ticketed person image, the ticket cannot be used by anyone except the original ticketed person. The ticket may also serve as a temporary identification document.

### CROSS-REFERENCE TO RELATED APPLICATION

This application claims priority pursuant to 35 U.S.C. § 119(e) to U.S. Provisional Application No. 60/367,791, filed Mar. 26, 2002, which application is specifically incorporated herein, in its entirety, by reference.

### BACKGROUND OF THE INVENTION

1. Field of the Invention

The present invention relates to a method and apparatus for issuing a nontransferable ticket for a transient event or service, such as an airplane flight or entertainment event.

2. Description of Related Art

The issuance of tickets for the purpose of controlling access to transient events, such as the boarding of a passenger airplane or other vessel, is an age-old practice. The use of tickets permits the collection of fares to be separated, both physically and temporally, from the gate-keeping activity of the ticketed event, thereby conferring numerous well-known advantages to the ticket issuer. Tickets are usually intended for a single use, or for a limited number of uses within a limited time frame just prior to, or during, the ticketed event. Thus, tickets may serve the purpose of an entry pass, conferring the benefit of entry to the holder.

Typically, tickets contain some printed information on a piece of paper or similar printable material. They may also include coded information, such as bar-coded information or information coded on a magnetic strip. The coded information may be read by a device at the point of entry to the ticketed event, thereby confirming the ticket holder's eligibility for entry.

Ticket issuers often desire to control transfer of issued tickets to other persons, to prevent or discourage the creation of a secondary market in the tickets, which might deprive the original issuer of some of its economic benefit. More recently, transferability of tickets has become a security concern, as well, such as in connection with the boarding of aircraft and other vessels. In this context, boarding passes are essentially “tickets” used during boarding. However, such tickets or passes are vulnerable to being transferred to someone other than the ticketed person (person to whom the ticket was originally issued), who may then use the ticket to board the aircraft instead of the ticketed person.

To prevent unauthorized transfer, the identity of the person boarding the aircraft may be checked at the gate, to ensure that the person boarding is the ticketed person named on the ticket. Such identity checks are usually performed by inspecting each person's identification document, such as a driver's license or passport bearing a photograph of the person. The process of checking identification is time consuming and can lead to a great deal of inconvenience to passengers, the vast majority of whom are properly ticketed. Moreover, under the time pressure of the entry gate, little time can be set aside for carefully checking identification documents. It is relatively easy, therefore, for a determined person to circumvent the system by preparing a false identification document in advance, or by stealing identification documents from someone with a similar appearance.

It is desirable, therefore, to provide a method and apparatus for issuing a non-transferable ticket that streamlines the process of admitting ticketed persons to a ticketed event, while reducing the likelihood that someone other than a ticketed person may use a stolen or improperly transferred ticket to gain entry.

### SUMMARY OF THE INVENTION

The present invention provides a method and apparatus for issuing a non-transferable ticket, that overcomes the limitations of the prior art.

In an embodiment of the invention, a request for a ticket is received at an off-line location, such as at a ticket counter or kiosk, in advance of the event. The ticket counter or kiosk may be equipped to receive a documentary or electronic form of identification, and verify the identity of the person requesting a ticket, and the ticket sale may be conditioned upon completion of a confirmation of identity. The ticket counter or kiosk is also equipped with an imaging device, such as a digital camera or scanner. An image is obtained of the person requesting the ticket, such as by using the digital imaging device. For example, a digital photograph of the ticketed person's face may be taken. In the alternative, or in addition, an image of the ticket requestor may be obtained from a secure database after confirmation of identity, or by scanning or otherwise extracting information from an identification document presented by the ticket purchaser.

The image of the ticketed person is then fixed, together with such other data that is desired, on a tangible ticket. For example, the ticket may be a paper or cardstock document, and the image may be a photograph of the ticketed person's face that is printed on the paper or cardstock adjacent to other ticket data. The ticket data includes, at minimum, the name or other identifier of the ticketed person, and an identifier for the ticketed event. The ticket is then issued, and serves as a temporary identification document for the ticketed person at the entry gate for the ticketed event, eliminating the need for additional identification documents. Advantageously, this embodiment may be relatively inexpensive to operate, because it does not require any equipment, except for at the point of sale.

For further example, the image of the ticketed person may be fixed with the ticket data in an encoded, machine-readable format. The encoded image may be read by a machine at the entry gate and the decoded image displayed to a gate keeper. The use of encoded data advantageously prevents the appearance of the images on a lost or stolen ticket from being known except by someone with a suitable configured viewing machine. For still greater security, images may be encrypted before being encoded on the ticket. Such ticket systems are more secure, but are also more expensive to set up and operate.

Images may be retained, such as in an electronic database, for use with future tickets. For example, a frequent airline customer may desire that her image be retained in an airline database, so that tickets with an identifying image may be issued from remote locations, such as over the Internet or at remote kiosks. In this embodiment, the identity of the ticketed person is verified using a password system. A ticket with an printed image of a ticket person may be created using any network client with access to a suitable printer, with assurance that that the image on the ticket belongs to the ticketed person.

In yet another embodiment, the image data is not fixed on the ticket itself, but is instead stored in a database in association with an alpha-numeric or other identifier of the ticketed person that is fixed on the ticket. The identifier may be encoded in a machine-readable format, for example, as an optical bar code. The database, including images of every ticketed person for a particular event, is accessible by a gate keeper for the event, such as through a network terminal. The gate keeper accesses an image for each ticketed person by using the identifier for ticket person in association with the database, causing the stored image to be displayed on the gate keeper's view screen. To speed entry of the identifier information and access to the images, the identifier may be read automatically, such as by using an optical scanner.

A more complete understanding of the method and apparatus for issuing a nontransferable ticket will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a diagram showing an exemplary system and apparatus for issuing a non-transferable ticket, according to an embodiment of the invention.

FIG. 2 shows an exemplary ticket that may be issued using the present invention.

FIG. 3 shows an alternative exemplary ticket that may be issued using the present invention.

FIG. 4 shows an exemplary screen shot for a gate keeper's view screen.

FIG. 5 is a flow diagram showing exemplary steps of a method according to the invention.

FIG. 6 is a diagram showing a second exemplary system and apparatus for issuing a non-transferable ticket, according to an embodiment of the invention.

FIG. 7 is a diagram showing a portion of a third exemplary system and apparatus for issuing a non-transferable ticket, according to an embodiment of the invention.

FIG. 8 is a flow diagram showing exemplary steps of a method according to an alternative embodiment of the invention.

### DETAILED DESCRIPTION OF THE PREFERRED EMBODIMENT

The present invention provides a method and apparatus for issuing a nontransferable ticket, that overcomes the limitations of the prior art. In the detailed description that follows, like element numerals are used to describe like elements appearing in one or more of the figures.

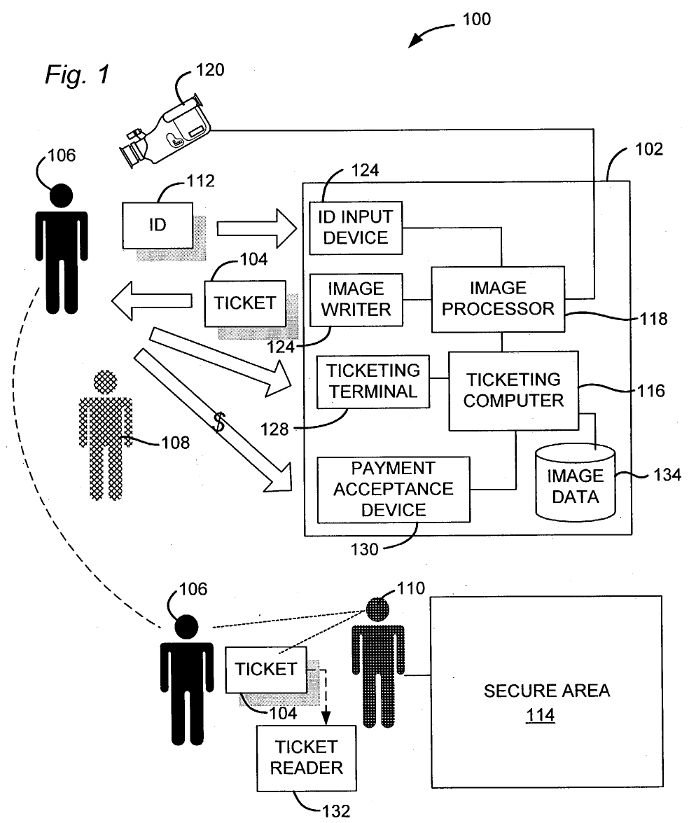

FIG. 1 shows a system 100 and apparatus 102 for issuing a non-transferable ticket 104 to a ticketed person 106. As used herein, “ticket” refers to a slip, pass, token, card or other suitable article indicating that a person has paid for or is entitled to receive a specified service, right, or consideration. A “paper ticket” refers to a ticket made of paper or paper-like material.

System 100 includes an apparatus 102 for preparing ticket 104, which indicates that ticketed person 106 is entitled to enter area 114. It is desired to ensure that ticket 104 can not be used by anyone other than person 104 to gain access to area 114. Agent 108 may assist person 106 in the operation of apparatus 102; in the alternative, person 106 may interact directly with apparatus 102. Gatekeeper 110 inspects ticket 104, observes ticketed person 106, and determines whether or not person 106 is permitted to enter area 114. One of the criteria for entry, of course, is whether or not the person 106 matches the image fixed on ticket 104. In addition, or in the alternative, a ticket-reading machine 132 may be used at the point of entry to area 114, to perform an automatic or human-assisted determination of eligibility for entry.

Apparatus 102 comprises a ticketing computer 116, an image processor 118, and an image fixing device 122. Ticketing computer 116 may be any general-purpose computer programmed to manage issuance of tickets to specific, identified persons for specific events or services. For example, computer 116 may comprise a computer with sophisticated software such as well-known in the art for issuing tickets for transportation services and entertainment events. For further example, computer 116 may be a special-purpose machine that merely facilitates the imprinting of textual ticket data on a paper ticket. The ticketing computer is not limited by a particular computer configuration or level of complexity.

An image processor 118 is operatively coupled to the ticketing computer 116. The image processor is capable of managing graphical image data in combination with alpha-numeric data or other encoded textual (non-image) information. The image processor may be implemented in hardware separate from computer 116, such as on another computer. In the alternative, the image processor 118 may be implemented using shared hardware with computer 116, such as by running an image-processing software program or module in computer 116. Software for image processing is readily available, or may be written by one of ordinary skill in the art.

Image fixing device 122 is operatively coupled to image processor 118, and is capable of fixing image data pertaining to ticketed passenger 106 onto ticket 104. In an embodiment of the invention, image fixing device 122 comprises a printer, for example, a thermal printer, a laser printer, an inkjet printer, or a dot-matrix printer. In an alternative embodiment, device 122 may comprise a magnetic or optical writer, capable of writing encoding data onto a magnetic or optical media. For example, device 122 may comprise a machine for encoding magnetic media in card or disc form. For further example, device 122 may comprise a machine for writing CD, DVD or other encoded data onto an optical disc or card.

Image fixing device 122 may be configured to fix both image and alpha-numeric ticket data on ticket 104, in one operation. In the alternative, fixation of image and ticket data may be performed separately, using separate operations in a single device, or separate operations by different devices. For example, in an embodiment of the invention, a ticket that already contains alpha-numeric ticket data may be inserted into image fixing device 122 to receive image data.

Optionally, apparatus 102 is operationally coupled to an imaging device, such as a digital camera 120, for capturing an image of the ticketed person 106. Any feature of the ticketed person that may serve to identify the person may be imaged. For example, in an embodiment of the invention, the person's face is imaged. In other embodiments, other parts of the person may be imaged, such as fingerprints, thumbprints, retinas, palms, or soles of the feet. Any suitable imaging device may be used, as known in the art. The imaging device 102 may be located near other elements of apparatus 102, or at a remote location. In the alternative, no imaging device is used, and the image of the ticketed person is retrieved from a database 134 for processing by image processor 118.

Apparatus 102 also optionally includes a terminal 128 to permit complex interactions between ticket person 106 or agent 108 and computer 116. Terminal 128 may include a view screen and conventional input devices, such as a keyboard and pointing device. Less conventional input devices, such as a spoken language recognition system, may also be used. In lieu of a terminal 128, person 106 may interact with computer 116 using an automated interface. For example, a fingerprint or retinal scan may be taken of the ticketed person to confirm the person's identity, and the ticket data retrieved from a database where it has been stored in a previous transaction. Such simplified, automated interfaces may be particularly appropriate for high-volume applications, such as an airport kiosks.

For some applications, it may be desirable to permit payment for the ticket at the point of issuance. For such applications, it may be desirable to include a payment acceptance device 130, operationally coupled to computer 116. Various payment devices are known in the art, for example, currency acceptors and card readers, and need not be described in detail. Any suitable device for accepting payment may be used.

For some applications, it may also be desirable to include an ID input device 124 for automatically inputting the ticketed person's documentary identification, coupled to the image processor 118 and/or computer 116. Input device 124 may comprise a special purpose device, designed to accept a specific type of identification document. A special purpose device may more readily read information from the identification document, because the format of the information is standardized. For example, some forms of identification include a magnetic strip in which certain information is encoded. For such documents, device 124 may comprise any suitable magnetic card reader as known in the art. The encoded information may be read and used for any desirable purpose, including confirming the identity of the ticketed person. A special-purpose input device, however, may be less desirable unless and until identification documents are more highly standardized, as many people may lack the requisite form of identification.

In the alternative, therefore, input device 124 may comprise a general purpose device designed to accept various different identification documents, such as passports from different countries, or licenses issued by different states. Actually reading alphanumeric information from a diversity of documents is theoretically possible, but entails complex programming and sophisticated hardware, and may be undesirable for most applications. Instead, a general-purpose input device may simply be used to record the overall appearance of the identification document presented by the ticketed passenger, as a graphical image. In such case, the input device 124 may comprise a frame, platen, or document holder into which a document may be placed or inserted while it is imaged, such as by using a digital camera or document scanner. The image of the identification document may then preserved as a record for inspection by a gatekeeper 110 on the face of the ticket 104, along with or instead of an image of the ticketed person.

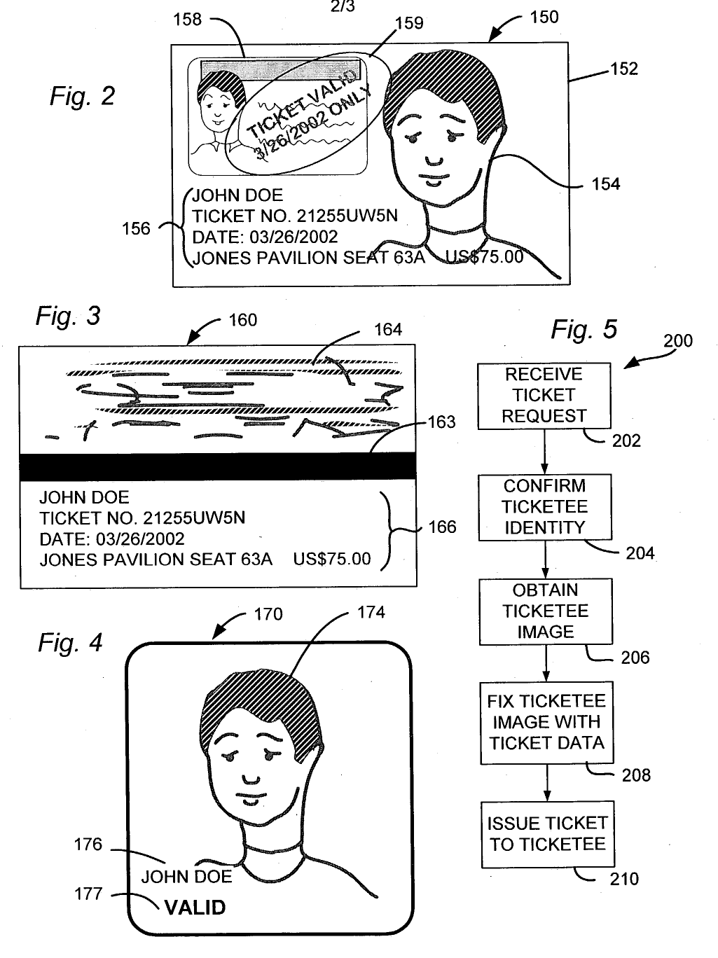

FIG. 2 shows an exemplary ticket 152 created using a method and apparatus according to the present invention. Ticket 152 comprises a substrate 152, comprised of any suitable material such as paper, plastic, cloth, or foil. An image 154 of at least a portion of the ticketed person is imprinted on a surface of the substrate, adjacent to ticket data 156. Ticket data 156 comprises the identity of the ticketed person and the ticketed event, and any other desired information. Exemplary ticket 150 includes ticket data in an imprinted, alpha-numeric form. In addition, or in the alternative, ticket 150 may include data in an encoded form, such as bar-coded or magnetically-coded data.

In addition to, or instead of image 154, ticket 150 may include an image 158 of the ticketed person's identification document; or if the ticketed person is a young child and has no identification document, an image of the identification document of the parent or guardian that purchased the ticket. To protect the ticketed person from identity theft, it may be desirable to obscure certain confidential information on the image 158 of the identification document, such as the person's home address, birth date, identification number, etc. This may be done by selectively blurring parts of image 158, or obscuring parts of image 158 with a superimposed mark, such as mark 159.

For a higher level of security, image data may be scrambled or encoded so that the image cannot be viewed without special equipment. FIG. 3 shows a ticket 160 comprising a scrambled image 164 of a ticketed person. Any suitable scrambling or encoding method may be used for the image data. Ticket 160 further comprises a magnetic strip 163 holding encoded ticket data, and well as printed alpha-numeric ticket data 166. The image of the ticketed person may be viewed by a gatekeeper by inserting the ticket 160 into a suitable reading machine, which de-scrambles or decodes image 164 and displays an image of the ticketed person on a view screen. Encoded ticket data may also be read and the ticket may be confirmed as valid, thereby easing the responsibilities of the gatekeeper. FIG. 4 shows an exemplary display 170 that may be presented on a view screen by a machine after ticket 160 is read. Display 170 shows a de-scrambled image 174 of the ticketed person, the person's name 176 and an indication 177 that the ticket is valid.

The exemplary system and apparatus described above may be used to perform a method 200 for issuing a non-transferable ticket, as diagrammed in FIG. 5. At step 202, a request for a ticket is received. The request may be received via an agent, as may occur at a ticket counter. Or the request may be received directly from the person requesting the ticket via a client terminal, as at a kiosk or through a remote network connection.

At step 204, the identity of the to-be ticketed person is confirmed. This may be done by checking identification documents when an agent is involved. When the person to be ticketed is making the request through a client terminal, the identity of the person may be confirmed via a password system.

At step 206, an image of at least a portion of the ticketed person is obtained. As previously discussed, the person's face may be imaged in a conventional manner, using a digital camera or any other suitable imaging device. In addition, or in the alternative, other features that serve to identify the person may be imaged, using other specialized imaging devices as known in the art. For example, the person's fingerprints or retinas may be imaged. Furthermore, instead of, or in addition to, capturing an image of the person at the time of ticketing, a previously-created image may be retrieved from a database.

Retrieval of the image from a database may be particularly useful when a ticket is being issued to a remote, unseen person. In such cases, it may not be feasible to compare the appearance of the person to the image on the person's identification documents, making the possibility of fraud somewhat more likely. To prevent an identity thief from using the ticket, the previously recorded image may be printed or otherwise fixed on the ticket. If a stored image of the ticketed person is available, it may also be advantageous to display it to the ticket agent at the time of ticketing, to deter the use of fraudulent identification documents. In the alternative, or in addition, the image may be obtained from the person's identification documents, such as by scanning such documents into a graphical data format.

At step 208, the image of the ticketed person is fixed on the ticket together with the appropriate ticket data, which includes, at minimum, an identifier of the ticketed person and of the ticketed event. The image may be fixed on the ticket by printing it as a recognizable graphical image, may be scrambled so as to be unrecognizable, or may be encoded as data in a machine-readable medium. Likewise, the ticket data may also be encoded, printed as alpha-numeric information, or both. For greater security, the data may also be encrypted.

At step 210, the ticket is issued to the ticketed person. The ticket may then be used by the person to gain access to the ticketed event or service.

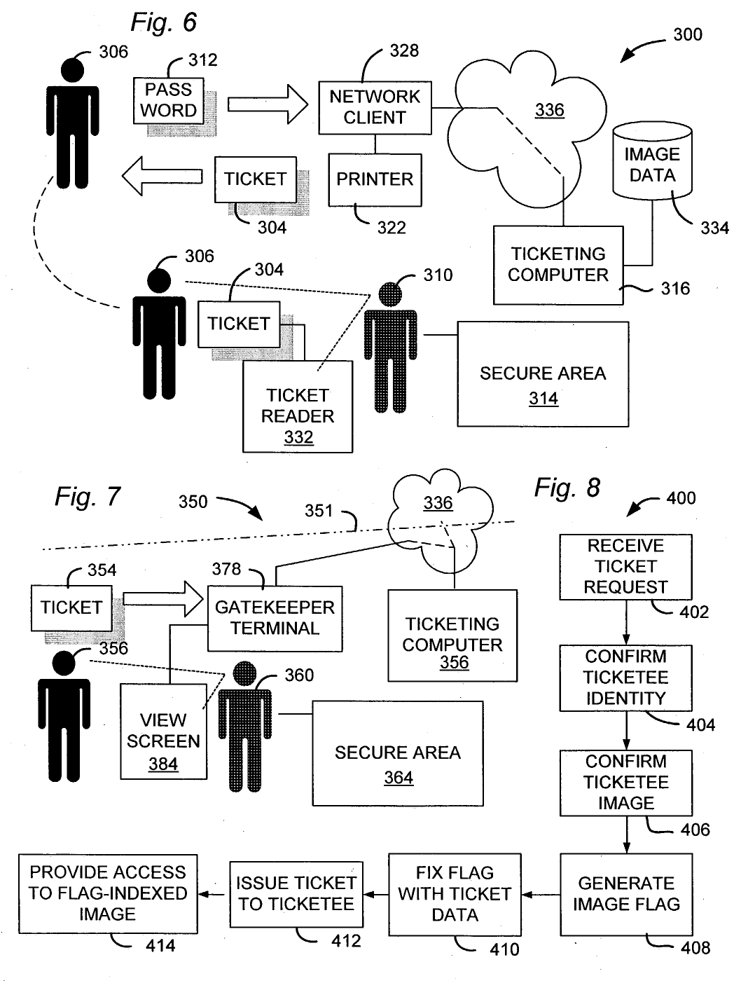

Various different methods and apparatus may be used within the scope of the invention. FIG. 6 shows a system 300 according to an alternative embodiment of the invention, for issuing a ticket to a ticket person at a remote location. Like system 100 described above, system 300 may be used to issue various different types of nontransferable tickets. System 300 may also include an imaging device, such as a camera (not shown), for imaging the ticketed person. The components shown in FIG. 3, however, are configured for obtaining an image from a preexisting database, as might be available for “frequent flyers,” or the like.

Person 306 transmits a ticket request to ticketing computer 316 via a network client 328. Client 328 and ticketing computer 316 communicate via network 326. Computer 316 has access to a image database 334, either through a direct connection (shown) or a network connection. The identity of the ticketed person is confirmed via a password 312. After the ticket has been purchased, the identity of person 306 confirmed, and an image of the person 306 obtained from the database 334, pertinent ticket data and image data are fixed together in a unitary file. The unitary file is configured so as to prevent the image from being erased and substituted with another image. The unitary ticket file is sent to client 328 and printed on printer 322 for immediate issuance to person 306. In the alternative, if time permits, the ticket may be printed or otherwise fixed on a tangible ticket media and a remote location, and mailed to an address specified by person 308. After being received by person 306, ticket 304 by be used to gain access to the specified event or service, such as entry into area 314, by presentation to a gate keeper 310. As previously described, encoded data on ticket 304 may be read by a ticket reading machine 332, if desired.

FIG. 7 shows a portion 350 of a system like either of systems 100 or 300 described above, or some combination thereof. Imaginary line 354 indicates that only a portion of an entire system is diagrammed. A system with portion 350 may be used with a ticketing method wherein image data is not actually contained on ticket 354. Instead, the ticket includes a flag or identifier for an image that is retained in an image database, such as database 334 (shown in FIG. 6). Except for this difference, the non-transferable ticket may be issued in any suitable manner as described above. An image of the ticketed person 356 may be obtained at the point of sale or of issuance as described in connection with FIG. 1, or may be retrieved from a previously-existing database.

During the ticketing process, the ticketing computer 356 generates a flag or identifier for the image of the ticketed person that is to be used with ticket 304, and stores the flag in association with the image in a database. The flag may be a randomly generated value, for greater security. The flag is recorded on ticket 304, preferably in encoded and/or encrypted form, as known in the art. The ticket is then issued to person 356, and may be presented to a gate keeper 360 to gain access to area 364, or to some other ticketed event or service.

Upon presentation, gatekeeper 360 reads the image identifier flag that is recorded on ticket 354, and if necessary, decodes or decrypts it. It is desirable to read the flag using a semi-automated system such as a bar-code reading machine or magnetic card reader. The flag is then sent to a ticketing computer 356, which retrieves the corresponding image and returns it to the terminal 378 for display on view screen 384. In the alternative, the image is sent to terminal 378 prior to reading ticket 354, and stored in a local database there. After ticket 354 is read, the corresponding image is retrieved from a local database for display on view screen 384. Use of a local database may speed up the retrieval of the ticketed person's image and reduce bandwidth and storage requirements on computer 356 and its associated connections to network 336. A predetermined time after the ticketed person has used the ticket, the image may be deleted from the database, be it a local or centralized system database. For example, after a particular flight has been completed without incident, the images used for entry may be deleted.

According to the foregoing, therefore, an alternative method 400 for issuing a non-transferable ticket has been disclosed, exemplary steps of which are outlined in FIG. 8. Steps 402-414 may be performed on any system with a portion 350 as described above. Method 400 may be particularly suitable for applications that employ a remote terminal for receiving the ticket request and/or issuing the ticket to the ticketed person, but is not limited to such systems. At step 402, a ticket request is received, in any suitable manner as described herein. For example, a request may be received from a network client over a wide area network connection, such as the Internet. At step 404, the identity of the to-be ticketed person is confirmed, again using any suitable process as described herein or as known in the art. In case of a request from a remote client, identity may be confirmed using a password system as known in the art.

At step 406, a database of images is searched to determine if an acceptable image for the ticketed person exists. The parameters of what is “acceptable” may vary according to the application. For more sensitive applications, more recent and more verifiable images may be required. If no acceptable image exists, the ticket requestor may be notified. If possible, arrangements may be made for supply of an acceptable image. If no image can be obtained, the ticketing process is postponed or aborted.

Provided that an acceptable image exists and is available, an image flag is generated at step 408. The flag may be any value that can serve to identify the image, that is, to serve as an index identifier for the image in a database of images. It may be desirable to generate the flag by a random process, so that it cannot readily be guessed. At step 410, the flag is fixed with ticket data, as previously described, on a ticket media. “Fixing” may be performed by printing a alpha-numeric, bar code, or other encoded data on a paper ticket, writing to a magnetic, optical, or electronic data storage media on or in the ticket, or in any suitable manner. If a paper ticket with encoded data is produced, it may be made to appear substantially like a conventional ticket.

At step 412, the ticket is issued to the ticketed person who may redeem it by presentation to a gate keeper. After the ticket is issued, and at least up until the time that the ticket is used, the image indexed by the flag that is recorded on the ticket is made available at the entry gate. Availability may be provided by downloading selected images to a terminal at the entry gate, by making the images available on demand from the entry terminal over a network connection, or by any other suitable method. Thus, when the ticket is read at the entry gate, the image of the ticketed person may be retrieved and displayed, so that the eligibility of the ticketed person to receive the ticketed service and/or to enter the secured area may be verified. After the ticket has been accepted for redemption, the image-identifying flag may be invalidated so as to no longer be useful for validation of the ticket by retrieval of the ticket-person image. In plainer terms, once used, the ticket no longer “works.”

Having thus described a preferred embodiment of a method and apparatus for issuing a non-transferable ticket, it should be apparent to those skilled in the art that certain advantages of the within system have been achieved. It should also be appreciated that various modifications, adaptations, and alternative embodiments thereof may be made within the scope and spirit of the present invention. For example, an embodiment involving issuance of a “paper” ticket has been illustrated, but it should be apparent that the inventive concepts described above would be equally applicable to embodiments that involve issuance of a ticket in an electronic or magnetic media. The invention is further defined by the following claims.

What is claimed is:

1. A method for issuing a non-transferable ticket for a transient event, the method comprising:
receiving a request for a ticket to a transient event, the request identifying at least a ticketed person and a transient event;
confirming a ticketed person identity;
obtaining a ticketed person image by imaging at least a portion of the ticketed person;
fixing the ticketed person image with ticket data in a suitable media, the ticket data comprising data identifying the ticketed person and the transient event; and
issuing a ticket to the ticketed person, the ticket comprising the suitable media in which the ticketed person image and the ticket data are fixed.

2. The method of claim 1, wherein the obtaining step further comprises obtaining the ticketed person image as an image of the ticketed person's face.

3. The method of claim 1, wherein the obtaining step further comprises obtaining the ticketed person image as an image selected from a fingerprint image, a thumbprint image, and handprint image, a footprint image, and a retina image.

4. The method of claim 1, wherein the fixing step further comprises printing the ticketed person image with ticket data in a suitable media selected from a paper media, a magnetic media, and a non-volatile electronic memory media.

5. The method of claim 1, wherein the obtaining step comprises obtaining a ticketed person image by imaging at least a portion of the identification document, the at least a portion of the identification document comprising a ticketed person image.

6. The method of claim 1, further comprising obtaining an image of at least a portion of the identification document.

7. The method of claim 6, wherein the fixing step further comprises fixing the image of the at least a portion of the identification document in the suitable media.

8. The method of claim 6, further comprising altering the image of the at least a portion of the identification document so as to remove selected ticketed person identification data from it.

9. The method of claim 6, further comprising altering the image of the at least a portion of the identification document so as to add a ticketing message stamp.

10. The method of claim 1, further comprising obtaining an image of at least a portion of a second identification document, the second identification document pertaining to a parent or guardian of the ticketed person; and
wherein the fixing step further comprises fixing the image of the at least a portion of the second identification document in the suitable media.

11. An apparatus for issuing a non-transferable ticket for a transient event, the apparatus comprising a computer having a memory, the memory containing instructions for:
receiving a request for a ticket to a transient event, the request identifying at least a ticketed person and a transient event;
confirming a ticketed person identity using a recorded identification document;
obtaining a ticketed person image by imaging at least a portion of the ticketed person;
fixing the ticketed person image with ticket data in a suitable media, the ticket data comprising data identifying the ticketed person and the transient event; and
issuing a ticket to the ticketed person, the ticket comprising the suitable media in which the ticketed person image and the ticket data are fixed.

12. The apparatus of claim 11, wherein the instructions further comprise instructions for obtaining the ticketed person image as an image of the ticketed person's face.

13. The apparatus of claim 11, wherein the instructions further comprise instructions for printing the ticketed person image with ticket data in a suitable media selected from a paper media, a magnetic media, and a non-volatile electronic memory media.

14. A method for issuing a non-transferable ticket for a transient event, the method comprising:
receiving a request for a ticket to a transient event, the request identifying at least a ticketed person and a transient event;
confirming a ticketed person identity;
confirming a ticketed person image;
generating an identifier for the ticketed person image;
fixing the identifier for the ticketed person image with ticket data in a suitable media, the ticket data comprising data identifying the ticketed person and the transient event;
issuing a ticket to the ticketed person, the ticket comprising the suitable media in which the ticketed person image and the ticket data are fixed; and
providing access to the ticketed person image indexed by the identifier at least until the ticket is presented for redemption.

15. The method of claim 14, wherein the fixing step further comprises printing the ticketed person image with ticket data in a suitable media selected from a paper media, a magnetic media, an optical media, and a non-volatile electronic memory media.

16. The method of claim 14, wherein the first confirming step comprises requiring the ticketed person to supply a predetermined password.

17. The method of claim 14, wherein the generating step further comprises generating the identifier comprising a random value.

18. The method of claim 14, further comprising invalidating the identifier after the ticket has been accepted for redemption.

19. The method of claim 14, wherein the second confirming step further comprises checking acceptance criteria for the image, the criteria comprising date and origin of the image.

20. The method of claim 14, wherein the second confirming step further comprises confirming the image as an image of the ticketed person's face.
